(19) United States
(12) Patent Application Publication
(10) Pub. No.: US 2020/0061603 A1
(43) Pub. Date: Feb. 27, 2020

(54) detection system of polychlorophenol in dyes

(71) Applicant: Huiting Ye, Guangzhou City (CN)

(72) Inventor: Huiting Ye, Guangzhou City (CN)

(21) Appl. No.: 16/673,932

(22) Filed: Nov. 4, 2019

(30) Foreign Application Priority Data
Jul. 26, 2019 (CN) 2019106802831

(51) Int. Cl. B01L 3/00

(52) U.S. Cl. CPC B01L 3/50; B01L 2300/0609; B01L 2400/06; B01L 2200/0689; B01L 2300/0851; B01L 2200/026; B01L 2200/025

(57) ABSTRACT

The invention discloses a detection system of polychlorophenol in dye, including a shell and a working chamber arranged in the shell, wherein the working chamber is provided with a rotatable connecting shaft, the upper end of the connecting shaft, is rotatably provided with a shaft mounting block, the upper side of the connecting shaft is provided with a rotary table, the lower end face of the rotary table is provided with a buffer chamber with a downward opening, and the shaft mounting block is located in the buffer chamber. The invention realizes the automation of the extraction step in the detection process of polychlorophenol, and can automatically add potassium carbonate solution to the dye. Compared with manual addition, the invention improves the accuracy, ensures the success of subsequent detection and improves the accuracy of detection. After the addition of potassium carbonate solution, the invention can Automatic oscillation improves efficiency.

### CROSS-REFERENCES TO RELATED APPLICATIONS

The present application claims priority from Chinese application No. 2019106802831 filed on Jul. 26, 2019 which is hereby incorporated by reference in its entirety.

### TECHNICAL FIELD

The present invention relates to the field of polychlorophenol detection, in particular to a detection system of polychlorophenol in dyes.

### BACKGROUND OF THE INVENTION

Chlorophenol is an important preservative, which can prevent the growth of fungi and inhibit the corrosion of bacteria. The detection method of polychlorophenol in dyes is basically tested according to the national standard GB/t24166-2009. Its principle is to mix potassium carbonate solution with dyes, extract them, acetylate them, and then get the results through chromatographic analysis. At present, this process Generally completed by human, the efficiency is relatively low, and in the process of extraction, the addition amount of potassium carbonate solution is relatively accurate, and there is certain uncertainty in manual operation. In view of the above problems, the invention is improved.

### BRIEF SUMMARY OF THE INVENTION

The technical problem to be solved by the invention is to provide a detection system of polychlorophenol in dyes.

The invention is realized by the following technical scheme.

The detection system of polychlorophenol in dye comprises a shell and a working chamber arranged in the shell. The working chamber is provided with a rotatable connecting shaft. The upper end of the connecting shaft is rotatably provided with a shaft mounting block, the upper side of the connecting shaft is provided with a rotary table, the lower end face of the rotary table is provided with a buffer chamber with a downward opening, and the shaft mounting block is located in the buffer chamber A buffer spring is connected between the shaft mounting block and the inner wall of the buffer chamber;

The upper end face of the rotary table is provided with five placing grooves, in which a clamping mechanism is arranged, the extracting bottle is placed in the placing groove and clamped by the clamping mechanism, the extracting bottle is provided with a dye sample, the top wall of the working chamber is fixed with a container, the container is provided with a container cavity, the container cavity is provided with a potassium carbonate solution, and the lower side of the container is provided with a valve mechanism The working chamber is provided with a positioning mechanism. The rotation of the connecting shaft drives the rotation of the extracting bottle through the rotary table. After the extracting bottle rotates to a designated position, the valve mechanism is opened under the action of the positioning mechanism, and the potassium carbonate solution in the container chamber enters the extracting bottle;

Further, the valve mechanism comprises a connecting pipe fixedly arranged at the lower side of the container and communicated with the container cavity, wherein the connecting pipe is fixedly provided with a valve, the top wall of the connecting pipe is fixedly provided with a fixing rod, the lower side of the connecting pipe is slidably provided with a connecting pipe, the lower end of the connecting pipe is fixedly provided with a moving pipe, the moving pipe is provided with a pipe cavity, and the bottom wall of the pipe cavity is provided with a moving pipe The lower end of the fixing rod extends to the through hole, and the lower end is fixed with a column block. The column block closes the through hole, and the valve opens to let the sodium carbonate solution enter the pipe cavity. When the extraction bottle reaches the designated position, the positioning mechanism drives the moving pipe to fall, and the column block is separated from the through hole, The liquid in the lumen flows into the extracting bottle.

Further, the positioning mechanism includes a support rod fixed on the back wall of the working chamber, the upper end face of the support rod is provided with an upper sliding groove, the upper sliding groove is provided with an upper sliding block, the upper sliding block and the back wall of the upper sliding groove are connected with a jacking spring, the upper sliding block extends upward and the upper end is fixed with an upper positioning rod, and the front end of the upper positioning rod is located at the rotary table On the upper side, when the extraction bottle moves to the front side of the upper positioning rod, press the upper positioning rod backward, the upper end face of the upper positioning rod is fixed with a connecting rod, one end of the connecting rod is fixed with a horizontal rack, the left wall of the working chamber is rotated with a gear shaft, the gear shaft is fixed with a gear meshing with the horizontal rack, and the rear end face of the mobile tube is fixed with a safety The rear end of the mounting rod is fixedly provided with a vertical rack meshed with the gear.

Further, the shell is provided with a power cavity which is located at the lower side of the working cavity and connected with the working cavity, the bottom wall of the power cavity is fixed with a motor, the upper side of the motor is connected with a power shaft, the upper end of the power shaft is fixed with a sector gear, the bottom wall of the power cavity is rotated with a rotating shaft, and the rotating shaft is fixed with a sector gear that can mesh with the sector gear The lower end of the connecting shaft extends into the power cavity, and the connecting shaft and the rotating shaft are connected by a first ratchet mechanism.

Further, the shelling mechanism includes the circular cavity with the opening upward, the rear wall of the circular cavity is provided with the driving cavity, the end wall between the driving cavity and the circular cavity is provided with the moving cavity, the top wall of the circular cavity is communicated with the feeding port, the circular cavity is communicated with the waste discharging port with the opening forward, and the circular cavity and the driving cavity are rotated with the front and rear extending the A rotating shaft, the first rotating shaft in the circular cavity is fixedly provided with the blade, and the blade is provided with circular holes arranged and distributed.

Further, the bottom wall of the power cavity rotates and is provided with a transmission shaft, the lower end of the camshaft extends into the power cavity and is connected with the transmission shaft through a second ratchet mechanism, the transmission shaft and the rotation shaft are connected through a belt wheel transmission, the rotation shaft and the bottom wall of the power cavity are connected with a torsion spring, the bottom wall of the power cavity is provided with a lower sliding groove, and A lower sliding block is slidably arranged in the sliding groove, a return spring is connected between the lower sliding block and the left wall of the lower sliding groove, the lower sliding block extends upward and the upper end is fixedly provided with a mounting plate, the right side of the mounting plate is equipped with a pawl meshed with the driving gear, the upper end of the mounting plate is fixedly provided with a top pressing block, and the lower end face of the rotary table is fixedly provided with a lower positioning rod, when all the extraction After the potassium carbonate solution in the bottle is added, the rotary table drives the lower positioning rod against the top pressing block, so that the pawl and the driving gear are separated.

Further, the clamping mechanism includes a storage cavity symmetrically arranged in the inner wall of the storage groove, wherein a clamping rod is slidably arranged, and a spring is connected between the clamping rod and the inner wall of the storage cavity.

Further, the buffer spring is provided with four.

Beneficial effect of the invention: the invention realizes the automation of the extraction step in the detection process of polychlorophenol, and can automatically add potassium carbonate solution to the dye. Compared with the manual addition, the invention improves the accuracy, ensures the success of the subsequent detection, and improves the detection accuracy. At the same time, after the addition of potassium carbonate solution, the invention can automatically oscillate and improve the efficiency.

### BRIEF DESCRIPTION OF THE DRAWINGS

In order to explain the embodiments of the invention or the technical solutions in the prior art more clearly, the following will give a brief introduction to the drawings needed in the embodiments or the prior art description. It is obvious that the drawings in the following description are only some embodiments of the invention. For ordinary technicians in the skill field, they can also use these drawings without paying creative labor Other figures are obtained from the figures.

FIG. 1 is the overall schematic structural diagram of the invention;

FIG. 2 is the structural diagram of “A-A” direction in FIG.1;

FIG. 3 is the structural diagram of “B-B” direction in FIG.1;

FIG. 4 is the structural diagram of “C-C” direction in FIG.1;

FIG. 5 is the structural diagram of “D-D” direction in FIG.1;

FIG.6 is an enlarged diagram of the “E” structure of FIG.2;

### DETAILED DESCRIPTION OF THE INVENTION

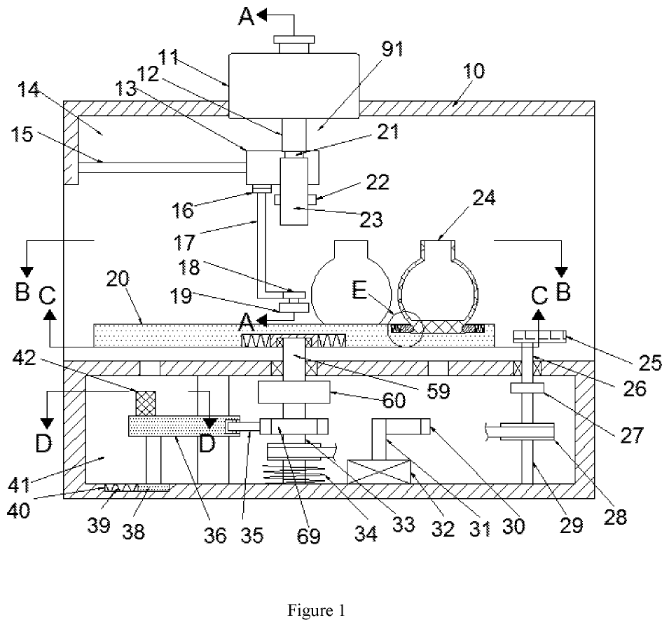

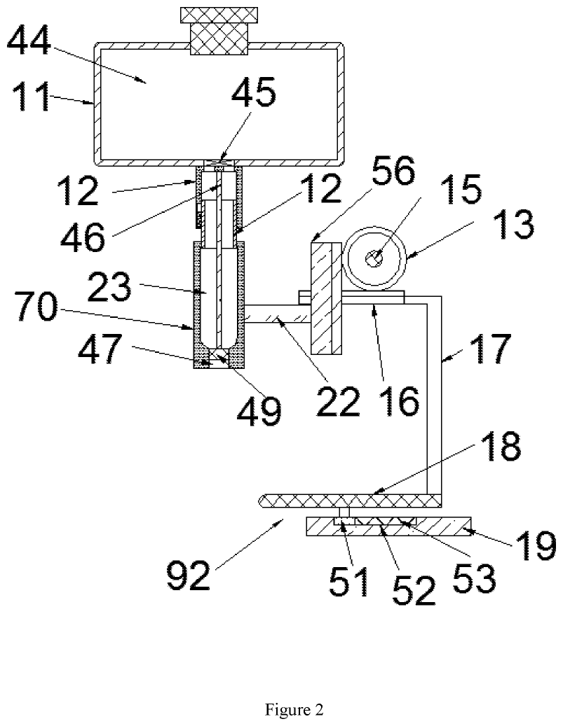

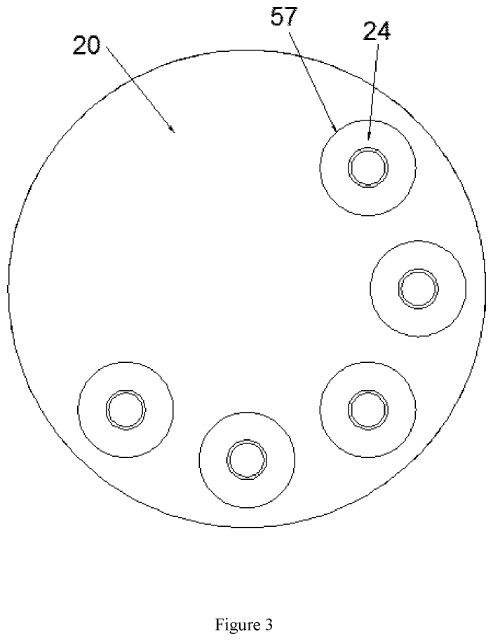

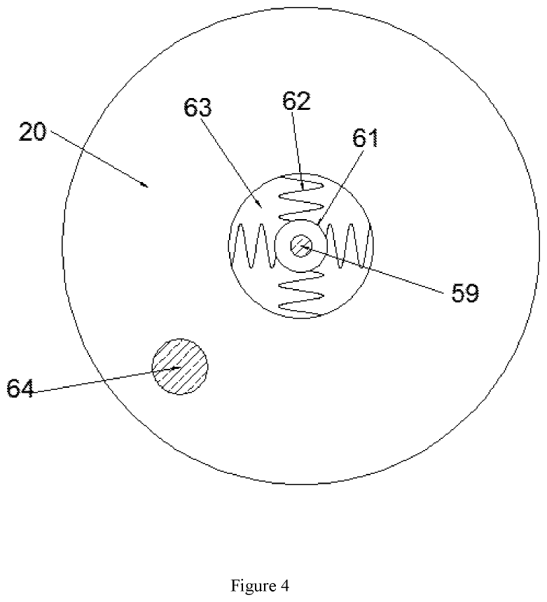

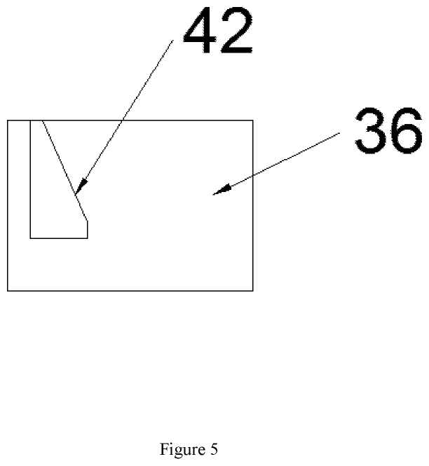

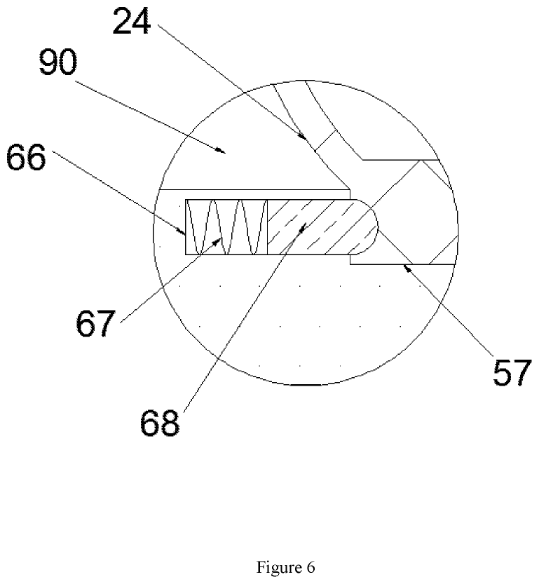

The detection system of polychlorophenol in dyes described in FIG. 1-6 mainly includes a shell 10 and a working chamber 14 arranged in the shell 10. The working chamber 14 is provided with a rotatable connecting shaft 59. The upper end of the connecting shaft 59 is rotatably provided with a shaft mounting block 61. The upper side of the connecting shaft 59 is provided with a rotary table 20. The lower end face of the rotary table 20 is provided with a buffer chamber 63 with a downward opening The shaft mounting block 61 is located in the buffer chamber 63, and a buffer spring 62 is connected between the shaft mounting block 61 and the inner wall of the buffer chamber 63;

The upper end face of the rotary table 20 is provided with five placing grooves 57, wherein the placing groove 57 is provided with a clamping mechanism 90, the extracting bottle 24 is placed in the placing groove 57 and clamped by the clamping mechanism 90, the extracting bottle 24 is provided with a dye sample, the top wall of the working chamber 14 is fixed with a container 11, the container 11 is provided with a container 44, the container 44 is provided with a potassium carbonate solution, and the container A valve mechanism 91 is arranged at the lower side of the device 11, and a positioning mechanism 92 is arranged in the working chamber 14. The rotation of the connecting shaft 59 drives the rotation of the extraction bottle 24 through the rotary table 20. After the extraction bottle 24 rotates to a designated position, the valve mechanism 91 is opened under the action of the positioning mechanism 92, and the potassium carbonate solution in the container chamber 44 enters the extraction bottle 24;

The bottom wall of the working chamber 14 is provided with a rotatable camshaft 26, and the upper side of the camshaft 26 is fixedly provided with a cam 25. When potassium carbonate solution is added to all the extraction bottles 24, the camshaft 26 drives the cam 25 to rotate, and the cam 25 circularly presses the rotary table 20 to drive the extraction bottle 24 to oscillate, so that the dye and the potassium carbonate solution are fully mixed.

The valve mechanism 91 includes a connecting pipe 12 fixedly arranged at the lower side of the container 11 and communicated with the container cavity 44. The connecting pipe 12 is fixedly provided with a valve 45, the top wall of the connecting pipe 12 is fixedly provided with a fixing rod 46, the lower side of the connecting pipe 12 is slidably provided with a connecting pipe 12, the lower end of the connecting pipe 12 is fixedly provided with a moving pipe 70, the moving pipe 70 is provided with a cavity 23, and the cavity 23 The bottom wall is provided with a through hole 47 which penetrates up and down, the lower end of the fixing rod 46 extends to the through hole 47, and the lower end is fixed with a column block 49, the column block 49 closes the through hole 47, the valve 45 is opened to make the sodium carbonate solution enter the pipe cavity 23, when the bottle 24 reaches the designated position, the positioning mechanism 92 drives the mobile pipe 70 to descend, so that the column The shape block 49 is separated from the through hole 47, and the liquid in the lumen 23 flows into the extraction bottle 24.

The positioning mechanism 92 includes a supporting rod 19 fixedly arranged on the rear wall of the working chamber 14, the upper end surface of the supporting rod 19 is provided with an upper sliding groove 52, the upper sliding groove 52 is provided with an upper sliding block 51, the upper sliding block 51 and the rear wall of the upper sliding groove 52 are connected with a jacking spring 53, the upper sliding block 51 extends upward and the upper end is fixedly provided with an upper positioning rod 18, the front end of the upper positioning rod 18 is located at When the extraction bottle 24 moves to the front side of the upper positioning rod 18, the upper end face of the upper positioning rod 18 is fixed with a connecting rod 17, one end of the connecting rod 17 is fixed with a horizontal rack 16, the left wall of the working chamber 14 is rotated with a gear shaft 15, and the gear 13 meshed with the horizontal rack 16 is fixed on the gear shaft 15, The rear end face of the mobile tube 70 is fixedly provided with a mounting rod 22, and the rear end of the mounting rod 22 is fixedly provided with a vertical rack 56 meshed with the gear 13.

The shell 10 is provided with a power cavity 41 located at the lower side of the working cavity 14 and connected with the working cavity 14, the bottom wall of the power cavity 41 is fixed with a motor 32, the upper side of the motor 32 is connected with a power shaft 31, the upper end of the power shaft 31 is fixed with a sector gear 30, the bottom wall of the power cavity 41 is rotated with a rotating shaft 33, and the rotating shaft 33 is fixed with a sector gear The lower end of the connecting shaft 59 extends into the power cavity 41, and the connecting shaft 59 is connected with the rotating shaft 33 through the first ratchet mechanism 60.

The bottom wall of the power cavity 41 rotates and is provided with a transmission shaft 29, the lower end of the camshaft 26 extends into the power cavity 41 and is connected with the transmission shaft 29 through a second ratchet mechanism 27, the transmission shaft 29 is connected with the rotation shaft 33 through a belt wheel 28, the rotation shaft 33 is connected with the bottom wall of the power cavity 41 by a torsion spring 34, and the bottom wall of the power cavity 41 is provided with a sliding surface The lower slide 38 is connected with the left wall of the lower slide 40, the lower slide 38 extends upward and the upper end is fixed with a mounting plate 36, the right side of the mounting plate 36 is installed with a pawl 35 which is meshed with the driving gear 69, the upper end of the mounting plate 36 is fixed with a top pressing block 42, and the lower end surface of the rotary table 20 is fixed There is a lower positioning rod 64. When the potassium carbonate solution in all the extraction bottles 24 is added, the rotation of the rotary table 20 drives the lower positioning rod 64 against the top pressing block 42, so that the pawl 35 is separated from the driving gear 69.

The clamping mechanism 90 includes a storage cavity 66 symmetrically arranged in the inner wall of the placing groove 57 left and right, the storage cavity 66 is slidably provided with a clamping rod 68, and a spring 67 is connected between the clamping rod 68 and the inner wall of the storage cavity 66.

The buffer spring 62 is provided with four.

Mechanical action sequence of the whole device:

1. Place the extracting bottle 24 in the placing groove 57, and fix the extracting bottle 24 by the clamping rod 68;

2. Place the dye sample in the extracting bottle 24, start the motor 32, drive the sector gear 30 to rotate through the power shaft 31, engage the sector gear 30 with the driving gear 69, drive the driving gear 69 to drive the rotating shaft 33 to rotate, thus drive the torsion spring 34 to accumulate the force, the rotating shaft 33 drives the connecting shaft 59 to rotate through the first echelon mechanism 60, and the connecting shaft 59 drives the rotary table 20 to rotate, so that the extracting bottle 24 can rotate to the top At the front side of the positioning rod 18, the sector gear 30 is separated from the driving gear 69;

3. The valve 45 is opened, the potassium carbonate solution in the container cavity 44 enters the pipe cavity 23, and the valve 45 is closed after a certain time;

4. The extraction bottle 24 presses the upper positioning rod 18 backward, the upper positioning rod 18 drives the horizontal rack 16 to move backward through the connecting rod 17 to drive the gear 13 to rotate, the gear 13 makes the vertical rack 56 move upward, the vertical rack 56 drives the moving tube 70 to move downward through the mounting rod 22, so as to separate the column 49 from the through hole 47, and the potassium carbonate solution in the tube cavity 23 enters the extraction bottle 24;

5. When the last extraction bottle 24 is rotated to the upper side of the top pressure block 42, the lower positioning rod 64 is opposite to the top pressure block 42 to press the top pressure block 42 to the left, and the top pressure block 42 drives the mounting plate 36 to move to the left to separate the pawl 35 from the transmission gear 69. Under the return function of the torsion spring 34, the rotating shaft 33 drives the transmission shaft 29 to rotate through the pulley 28, and the transmission shaft 29 drives the cam 25 through the second ratchet mechanism 27 and the camshaft 26 Rotation;

6. The cam 25 circulates the top pressure of the rotary table 20, so that the rotary table 20 drives the extraction bottle 24 to vibrate, so that the potassium carbonate solution and the dye are fully mixed.

The above embodiments are only to illustrate the technical concept and features of the invention, and the purpose is to enable people familiar with the technology in the field to understand the content of the invention and implement it, and not to limit the scope of protection of the invention. Any equivalent change or modification according to the spirit and substance of the invention shall be covered in the protection scope of the invention.

1. A detection system of polychlorophenol in dyes, comprising a shell and a working chamber arranged in the shell, which is characterized in that: the working chamber is provided with a rotatable connecting shaft, the upper end of the connecting shaft is rotatably provided with a shaft mounting block, the upper side of the connecting shaft is provided with a rotary table, the lower end surface of the rotary table is provided with a buffer chamber with a downward opening, the shaft mounting block is located in the buffer chamber, and the shaft mounting block and the inner wall of the buffer chamber A buffer spring is connected between them;
The upper end face of the rotary table is provided with five placing grooves, in which a clamping mechanism is arranged, the extracting bottle is placed in the placing groove and clamped by the clamping mechanism, the extracting bottle is provided with a dye sample, the top wall of the working chamber is fixed with a container, the container is provided with a container cavity, the container cavity is provided with a potassium carbonate solution, and the lower side of the container is provided with a valve mechanism The working chamber is provided with a positioning mechanism. The rotation of the connecting shaft drives the rotation of the extracting bottle through the rotary table. After the extracting bottle rotates to a designated position, the valve mechanism is opened under the action of the positioning mechanism, and the potassium carbonate solution in the container chamber enters the extracting bottle;
The bottom wall of the working chamber is provided with a rotatable camshaft, and the upper side of the camshaft is fixed with a cam. When potassium carbonate solution is added to all the extraction bottles, the camshaft drives the cam to rotate, and the cam circulates to press the rotary table so that the rotary table drives the extraction bottle to oscillate, so that the dye and the potassium carbonate solution are fully mixed.

2. The detection system of polychlorophenol in dyes as defined in claim 1, wherein The valve mechanism comprises a connecting pipe fixedly arranged at the lower side of the container and communicated with the container cavity, wherein the connecting pipe is fixedly provided with a valve, the top wall of the connecting pipe is fixedly provided with a fixing rod, the lower side of the connecting pipe is slidably provided with a connecting pipe, the lower end of the connecting pipe is fixedly provided with a moving pipe, the moving pipe is provided with a pipe cavity, and the bottom wall of the pipe cavity is provided with an upper and lower penetrating Through hole, the lower end of the fixing rod extends to the through hole, and the lower end is fixedly provided with a column shaped block, the column shaped block seals the through hole, the valve opens to let the sodium carbonate solution enter the tube cavity, when the extraction bottle reaches the designated position, the positioning mechanism drives the moving tube to fall, so that the column shaped block is separated from the through hole, and the tube cavity And the liquid flows into the extracting bottle.

3. The detection system of polychlorophenol in dyes as defined in claim 2, wherein The positioning mechanism includes a supporting rod fixed on the back wall of the working chamber, the upper end face of the supporting rod is provided with an upper sliding groove, the upper sliding groove is provided with an upper sliding block, the upper sliding block and the back wall of the upper sliding groove are connected with a jacking spring, the upper sliding block extends upward and the upper end is fixed with an upper positioning rod, the front end of the upper positioning rod is located on the upper side of the rotary table, and the upper end of the upper positioning rod is fixed with an upper positioning rod When the extracting bottle moves to the front side of the upper positioning rod, press the upper positioning rod backward, the upper end face of the upper positioning rod is fixed with a connecting rod, one end of the connecting rod is fixed with a horizontal rack, the left wall of the working chamber is rotated with a gear shaft, the gear shaft is fixed with a gear meshing with the horizontal rack, the rear end face of the moving tube is fixed with a mounting rod, and the The rear end of the mounting rod is fixedly provided with a vertical rack meshed with the gear.

4. The detection system of polychlorophenol in dyes as defined in claim 1, wherein The shell is provided with a power cavity which is located at the lower side of the working cavity and communicated with the working cavity, the bottom wall of the power cavity is fixed with a motor, the upper side of the motor is connected with a power shaft, the upper end of the power shaft is fixed with a sector gear, the bottom wall of the power cavity is rotating with a rotating shaft, and the rotating shaft is fixed with a transmission gear which can mesh with the sector gear, The lower end of the connecting shaft extends into the power cavity, and the connecting shaft and the rotating shaft are connected through a first ratchet mechanism.

5. The detection system of polychlorophenol in dyes as defined in claim 4, wherein The bottom wall of the power cavity rotates and is provided with a transmission shaft, the lower end of the camshaft extends into the power cavity and is connected with the transmission shaft through a second ratchet mechanism, the transmission shaft and the rotation shaft are connected through a belt wheel transmission, the rotation shaft and the bottom wall of the power cavity are connected with a torsion spring, the bottom wall of the power cavity is provided with a lower sliding groove which slides in the middle A lower slider is movably provided with a return spring connected between the lower slider and the left wall of the lower chute, the lower slider extends upward and the upper end is fixedly provided with a mounting plate, the right side of the mounting plate is provided with a pawl meshed with the driving gear, the upper end of the mounting plate is fixedly provided with a top pressing block, and the lower end surface of the rotary table is fixedly provided with a lower positioning rod, when all potassium carbonate in the extraction bottle is After the solution is added, the rotation of the rotary table drives the lower positioning rod against the jacking block, so that the pawl and the transmission gear are separated.

6. The detection system of polychlorophenol in dyes as defined in claim 1, wherein The clamping mechanism includes a storage cavity symmetrically arranged in the inner wall of the storage groove, in which a clamping rod is slidably arranged, and a spring is connected between the clamping rod and the inner wall of the storage cavity.

7. The detection system of polychlorophenol in dyes as defined in claim 1, wherein The buffer spring is provided with four.
